(19) United States
(12) Patent Application Publication
(10) Pub. No.: US 2007/0297409 A1
(43) Pub. Date: Dec. 27, 2007

(54) MESSAGE INDENTIFICATION SYSTEM AND METHOD

(75) Inventors: Chaucer Chiu, Taipei (TW); Sean Liu, Taipei (TW)

Correspondence Address: ISHIMARU & ZAHRT LLP, 333 W. EL CAMINO REAL, SUITE 330, SUNNYVALE, CA, 94087, US

(73) Assignee: INVENTEC CORPORATION, Taipei (TW)

(21) Appl. No.: 11/563,654

(22) Filed: Nov. 27, 2006

(30) Foreign Application Priority Data
Jun. 27, 2006 (TW) 095123093

(51) Int. Cl. H04L 12/56

(52) U.S. Cl. 370/392; 370/401

(57) ABSTRACT

A message identification system and method, which is applicable to an electronic communication device capable of sending and receiving messages; includes the following steps: acquiring the communication number of a sending end whose sending message is received by the electronic communication device; comparing the communication number of the sending end with a default communication number, if the communication number of the sending end is identical to the default communication number, storing the received message in a first storage sub-unit, otherwise, the communication number of the sending end is not identical to the default communication number, creating a connection between the electronic communication device and the sending end; next, if the creating of the connection between the electronic communication device and the sending end succeeds, storing the received message in a second storage sub-unit, otherwise, the creating of the connection between the electronic communication device and the sending end fails, storing the received message in a third storage sub-unit. In the present invention, the message identification system and method automatically identifies a junk message by the communication number of a sending end, therefore, it saves the users a great deal of time of reading and identifying junk messages, meanwhile, it also helps the users reduce the risk of being deceived.

### BACKGROUND OF THE INVENTION

1. Field of the Invention

This invention relates generally to message identification techniques, and more particularly, to a message identification system and method capable of identifying junk messages automatically.

2. Description of Related Art

Accordingly, an electronic communication device capable of sending and receiving message, such as a cellular phone, for its great portability, has become an essential means of communication in people's daily life. However, as the cellular phones become more popular recently, numerous cellular phone users have to face the problems caused by more and more “junk messages” and “annoying messages”. Many cellular phone users receive a massive amount of junk messages from networks and other cellular phone users. These junk messages, such as commercials, blackmails, or frauds, not only influence a user's mood but also waste the user a great deal of time of reading and identifying them. Or even worse, some of the junk messages are full of tricky information of frauds, such as falsity prizes, deceitful messages to get users pay for phone bills or get the information of users' bank accounts, etc., all of these deceitful messages cause users unnecessary financial loss easily.

Presently, the sending end of a junk message makes the use of a one time payment fee (e.g. a prepaid phone card) to pay for a communication number. Specifically, the sending end takes the advantage of using the same one communication number to send out a massive amount of messages, after the one time payment fee is used up, the communication number is no longer available. For that reason, the communication number used by the sending end is basically a fake account, in other words, it is impossible for the message receiving end to make a connection with the sending end.

Hence, how to provide a message identification technique to identify a junk message by using the communication number of a sending end has become a highly urgent problem to be solved.

### SUMMARY OF THE INVENTION

In views of the above-mentioned shortcomings of the prior art, it is a primary objective of the present invention to provide a message identification system and method capable of identifying junk messages by identifying a communication number of a sending end which sends the junk messages.

It is another objective of the present invention to provide a message identification system and method, which is capable of automatically differentiating normal messages from junk messages, thereby saving user a great deal of time on reading and identifying coming messages, as well as helping user to reduce the risk of being deceived.

To achieve the above-mentioned and other objective, a message identification system and method is provided according to the present invention. The message identification system and method is applicable to an electronic communication device capable of sending and receiving messages, wherein, the electronic communication device is a cellular phone. The message communication system includes: a storage unit, which is used to store the messages received by the electronic communication device, the storage unit also comprises a first storage sub-unit, a second storage sub-unit, and a third storage sub-unit; an acquiring module, which is used to acquire the communication number of a sending end whose sending message is received by the electronic communication device; a comparison module, which is used to compare the communication number of the sending end acquired by the acquiring module with at least one of the default communication numbers, and if the communication number of the sending end is identical to the default communication number, store the received message in the first storage sub-unit; and a connection module, which is used to create a connection between the electronic communication device and the sending end if the communication number of the sending end is not identical to the default communication number as a result of comparing derived from the comparison module, and if the creating of a connection between the electronic communication device and the sending end succeeds, store the received message in the second storage sub-unit, otherwise, the creating of a connection between the electronic communication device and the sending end fails, store the received message in the third storage sub-unit.

In a better exemplary embodiment, the first storage sub-unit is a storage area for storing normal messages, the second storage sub-unit is a storage area for storing messages to be identified, and the third storage sub-unit is a storage area for storing junk messages; the default communication number is one of the communication numbers of contacts and particular communication services stored in the address book of the electronic communication device; the comparison module further compares the communication number of the sending end with at least one default junk message communication number, and if the communication number of the sending end is identical to the default junk message communication number, store the received message in the third storage sub-unit; besides, the message identification system of the present invention further comprises a changing module, which is used to change the storage locations of received messages stored in the first storage sub-unit, the second storage sub-unit, and the third storage sub-unit.

In correspondence to the above-described message identification system, the present invention further disclosures a message identification method, comprising the following steps: provide a storage unit, which is used to store the messages received by the electronic communication device, the storage unit includes a first storage sub-unit, a second storage sub-unit, and a third storage sub-unit; acquire the communication number of a sending end whose sending message is received by the electronic communication device; compare the acquired communication number of the sending end with at least one default communication number, and if the communication number of the sending end is identical to the default communication number, store the received message in the first storage sub-unit; if the communication number of the sending end is not identical to the default communication number, create a connection between the electronic communication device and the sending end, and if the creating of the connection between the electronic communication device and the sending end succeeds, store the received message in the second storage sub-unit; next, if the communication number of the sending end and the default communication number are not identical, and the creating of a connection, based on the communication number of the sending end whose sending message is received, between the electronic communication device and the sending end fails, store the received message in the third storage sub-unit.

Wherein, the first storage sub-unit is a storage area used to store normal messages, the second storage sub-unit is a storage area used to store messages to be identified, and the third storage sub-unit is a storage area used to store junk messages; the default communication number is one of the communication numbers of contacts and particular communication services stored in the address book of the electronic communication device. Besides, the message identification method of the present invention further comprises the following steps: compare the communication number of the sending end with at least a default junk message communication number, and if the communication number of the sending end is identical to the default junk message communication number, store the received message in the third storage sub-unit; and change the storage locations of received messages stored in the first storage sub-unit, the second storage sub-unit, and the third storage sub-unit.

Hence, the present invention automatically identifies whether a message is a normal message, a message to be identified or a junk message by using the communication number of a sending end whose sending message is received, in other words, there is no need for the user to read a message before knowing whether it is junk message or not, thereby, saving the user's time of reading and identifying a message; meanwhile, with the junk messages stored in the third storage sub-unit and the messages to be identified stored in the second storage sub-unit, users can choose either to delete directly or not to read, therefore, users can avoid reading messages with fraudulent information, consequently, it helps users reduce the risk of being deceived.

### BRIEF DESCRIPTION OF DRAWINGS

The present invention can be more fully understood by reading the following detailed description of the preferred embodiments, with reference made to the accompanying drawings, wherein:

FIG. 1 is a functional block diagram of a instant message and a message identification system according to the present invention; and

FIG. 2 is a flow chart of a message identification method according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

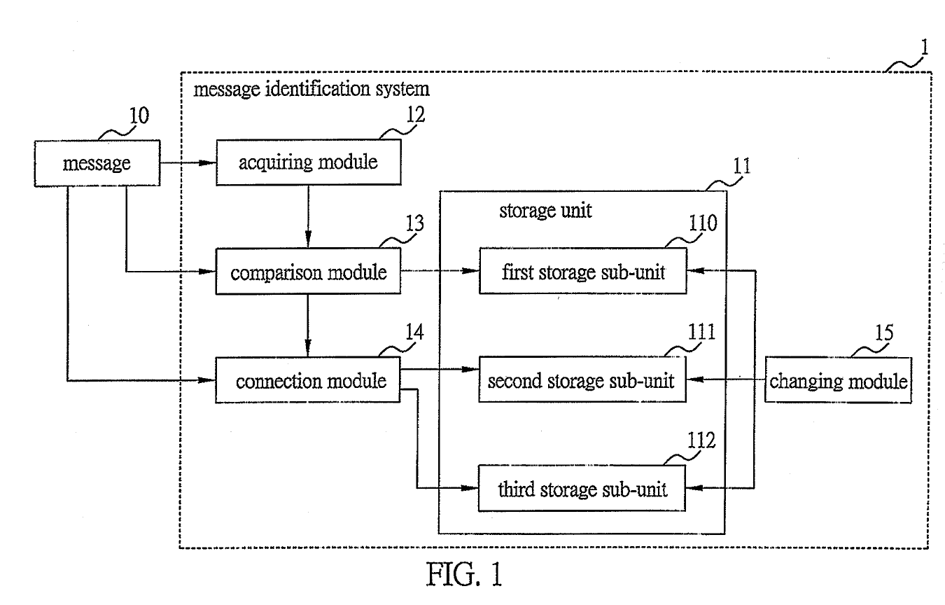

FIG. 1 is a function block diagram of instant messages 10 and a message identification system 1 according to the present invention. The message identification system 1 is applicable to an electronic communication system such as a cellular phone capable of sending and receiving instant messages. The message identification system 1 comprises a storage unit 11, an acquiring module 12, a comparison module 13, a connection module 14, and a changing module 15.

The storage unit 11 is used for storing the messages 10 received by the electronic communication device, and includes a first storage sub-unit 110, a second storage sub-unit 111, and a third storage sub-unit 112. The storage unit 11 is a memory of the electronic communication device. In the present exemplary embodiment, the first storage sub-unit 110 is a storage area for storing normal messages, the second storage sub-unit 111 is a storage area for storing messages to be identified, and the third storage sub-unit 112 is a storage area for storing junk messages. In other words, the storage unit 11 stores a received message 10 in a storage sub-unit based on its type (normal message, message to be identified, or junk message).

The acquiring module 12 acquires a communication number of a sending end sending the message 10. In other words, in order to obtain a source of a received message 10, the acquiring module 12 acquires the communication number of a sending end, which sends the message 10.

The comparison module 13 compares the acquired communication number of the sending end received by the acquiring module 12 with at least a default communication number, and stores the received message in the first storage sub-unit 110 if the communication number of the sending end is identical to the default communication number. Specifically, a default communication number, which is preset by the user of an electronic communication device, can be one of the communication numbers of contacts and particular communication services stored in an address book of the electronic communication device. The comparison module 13 compares the communication number of a sending end with the default communication number, that the communication number of the sending end is identical to one of the communication numbers of the contacts and particular communication services stored in the address book means that the message 10 is a normal message, then, the comparison module 13 stores the message 10 in the first storage sub-unit 110, which is used to store normal messages.

In the present exemplary embodiment, the comparison module 13 further compares the communication number of the sending end with at least a default junk message communication number, and stores the received message in the third storage sub-unit 112 if the communication number of the sending end is identical to the default junk message communication number. The default junk message communication number can be preset either by the user of the electronic communication device or after the user confirms a message received by the electronic communication device as a message to be identified or a junk message, the comparison module 13 compares the communication number of the sending end with a default junk message communication number, if the communication number of the sending end is identical to the default junk message communication number, it means that the message 10 is a junk message, the comparison module 13 stores the message 10 in the third storage sub-unit 112, which is used to store junk messages.

The connection module 14, based on comparing results derived from the comparison module 13, creates a connection between the sending send and the electronic communication device if the communication number of a sending end is not identical to a default communication number, and stores the received message 10 in the second storage sub-unit 111 if the creating of the connection between the electronic communication device and the sending end succeeds. Otherwise, the creating of the connection between the electronic communication device and the sending end fails, stores the received message in the third storage sub-unit 112. Specifically, based on the comparing results derived from the comparison module 13, the connection module 14 tries to connect the sending end with the electronic communication device, for example, by returning a message to the sending end of the acquired communication number to connect the electronic communication device with the sending end, if the acquired communication number of the sending end is identical to neither a default communication number nor a default junk message communication number. If the electronic communication device is connected successfully with the sending end, the messages 10 may not be a junk message but a message to be identified, and the connection module 14 thus stores the messages 10 in the second storage sub-unit 111, which is used for storing messages to be identified, and disconnects the electronic communication device with the sending end. If the electronic communication device is nor connected successfully with the sending end, the messages 10 is a junk message, and the connection module 14 stores the messages 10 in the third storage sub-unit 112, which is used for storing junk messages.

The changing module 15 changes storage locations where the received messages 10 are stored in the first storage sub-unit 110, the second storage sub-unit 111, and the third storage sub-unit 112. In the present exemplary embodiment, the user is allowed to use the changing module 15 to relocate the messages 10, which may be stored in the first storage sub-unit 110, the second storage sub-unit 111, or the third storage sub-unit 112. For example, if the user considers that the message 10 stored in the second storage sub-unit 111 are junk messages, the user is allowed to use the changing module 15 to relocate the messages 10 to the third storage sub-unit 112 and preset the communication number of the sending end as a default junk message communication number. Thereafter, any received messages sent from the sending end of this communication number will be sent directly to the third storage sub-unit 112. If the user considers that the messages 10 stored in the second storage sub-unit 111 are useful and interesting messages, the user can use the changing module 15 to relocate the messages 10 to the first storage sub-unit 110.

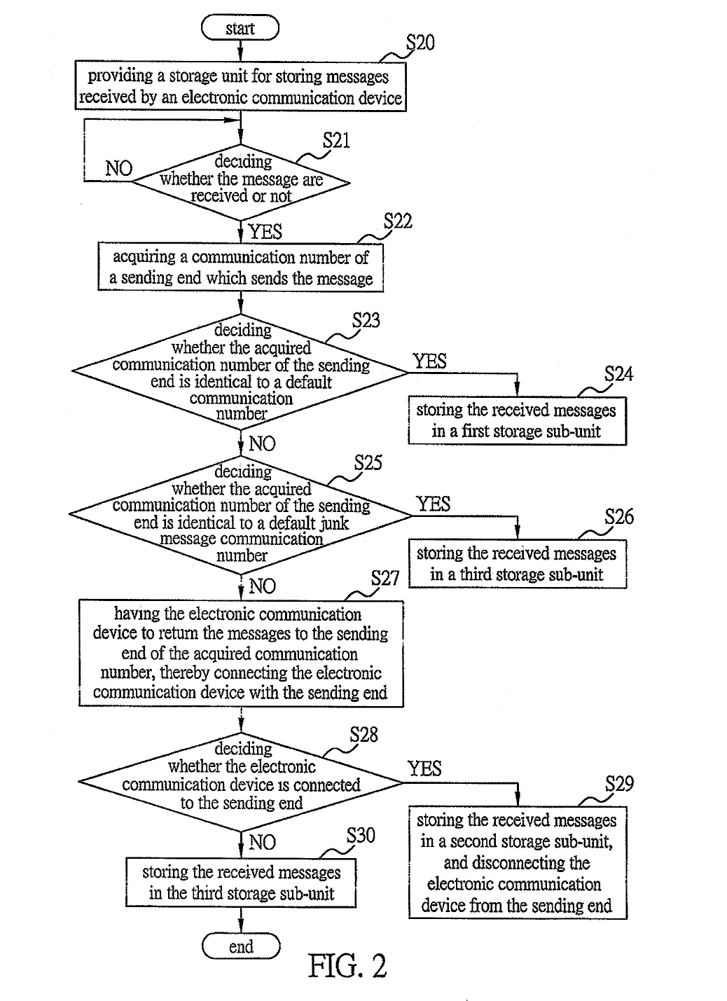

Corresponding to the above-described message identification system, the present invention further provides a message identification method. Please refer to FIG. 2, which is a detailed flowchart of an exemplary embodiment of the message identification method according to the present invention, the message identification method is applicable to an electronic communication device (e.g. a cellular phone) capable of sending and receiving message. As illustrated, the process begins at step S20: provide a storage unit 11, for storing a message received by an electronic communication device, and based on the type of message, the storage unit is divided into a first storage sub-unit 110 for storing normal messages, a second storage sub-unit 111 for storing messages to be identified, and a third storage sub-unit 112 for storing junk messages. Proceed to step S21.

In step S21, the electronic communication device decides whether a message is received or not, if a message is received, proceed to step S22; if a message is not received, keep processing in step S21.

In step S22, acquire the communication number of a sending end whose sending message is received by the electronic communication device. Proceed to step S23.

In step S23, decide whether the acquired communication number of the sending end is identical to at least a default communication number (the communication number of a contact or a particular communication service, which is stored in the address book of the electronic communication device), if yes, proceed to step S24; otherwise, proceed to step S25

In step S24, store the received message in the first storage sub-unit 110, which is used to store normal messages. In the present step, the communication number of the sending end is identical to a default communication number (the communication number of a contact or a particular communication service stored in the address book of the electronic communication service), it means that the message is a normal message, therefore, the message is stored in the first storage sub-unit 110.

In step S25, decide whether the acquired communication number of the sending end is identical to at least a default junk message communication number, if yes, proceed to step S26; otherwise, proceed to step S27.

In step S26, store the received message in the third storage sub-unit 112, which is used to store junk messages. In the present step, the acquired communication number of the sending end is identical to a junk message communication number, it means that the received message is a junk message, therefore, the received message is stored in the third storage sub-unit 112, which is used to store junk messages.

In step S27, make the electronic communication device return a message to the sending end of the acquired communication number, thereby, creating a connection between the electronic communication device and the sending end. Proceed to step S28.

In step S28, decide whether the creating of the connection, based on the communication number of the sending end whose sending message is received, between the electronic communication service and the sending end succeeds or not, if yes, proceed to step S29; otherwise, proceed to step S30.

In step S29, store the received message in the second storage sub-unit 111, which is used to store messages to be identified, and disconnect the connection between the electronic communication device and the sending end. In the preset step, if the creating of connection between the electronic communication device and the sending end succeeds, it means that the received message may not be a junk message but a message to be identified, therefore, store the message in the second storage sub-unit 111, which is used to store messages to be identified.

In step S30, store the received message in the third storage sub-unit 112, which is used to store junk messages. In the present step, the electronic communication device can not make a connection with this sending end, it means that the received message is a junk message, therefore, store the message in the third storage sub-unit 112, which is used to store junk messages.

Besides, in the present exemplary embodiment, the message identification method further comprises a changing step, which changes the storage locations of received messages stored in the first storage sub-unit 110, the second storage sub-unit 111, and the third storage sub-unit 112 (not shown in the figure.) For instance, if a user considers that a message stored in the second storage sub-unit 111 as a junk message, the user can relocate the message to the third storage sub-unit 112 and preset the communication number of the sending end as a default junk message communication number, thereafter, any received message sent from the sending end of this communication number will be sent directly to the third storage sub-unit 112, which is used to store junk messages; if the user considers that a message stored in the second storage sub-unit 111 as an interesting message, the user can relocate the message to the first storage sub-unit 110, which is used to store normal message.

In summary, the message identification system and method of the present invention, first, in order to identify whether a received message is a normal message or a junk message, compares the communication number of a sending send whose sending message is received by an electronic communication device, with a default communication number and a default junk message communication number; by means of creating a connection between an electronic communication device and a sending end, further identifies whether a received message is a message to be identified or a junk message; according to the means mentioned above, store the message received by the electronic communication device in a corresponding storage area based on the type of the message (normal message, message to be identified, and junk message). Therefore, the present invention automatically identifies a normal message, a message to be identified, and a junk message by using the communication number of a sending end whose sending message is received, in other words, there is no need for the user to read a message before knowing whether it is a junk message or not, thereby, saving the user's time of reading and identifying a message; meanwhile, with the junk messages stored in the third storage sub-unit 112 and the messages to be identified stored in the second storage sub-unit 111, users can choose either to delete directly or not to read, therefore, users can avoid reading messages with fraudulent information, consequently, it helps users reduce the risk of being deceived.

Besides, a user can change the type of a message by changing its storage location according to the need of the user. Therefore, if a sending end can be made a connection with the electronic communication device, user can preset the communication number of the sending end as a default junk message communication number, thereafter, any received message sent from the sending end of this communication number will be sent directly to the third storage sub-unit 112, which is used to store junk messages, meanwhile, the user will not miss any important message; therefore, the message identification system and method of the present invention provides more advantages for users to manage received messages.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A message identification system applicable to an electronic communication device capable of sending and receiving messages, the message identification system comprising:
a storage unit for storing the messages received by the electronic communication device, the storage unit comprising a first storage sub-unit, a second storage sub-unit, and a third storage sub-unit;
an acquiring module for acquiring a communication number of a sending end which sends the messages;
a comparison module for comparing the communication number of the sending end acquired by the acquiring module with a default communication number, and storing the received message in the first storage sub-unit if the communication number of the sending end is compared to be identical to the default communication number; and
a connection module for connecting the sending end to the electronic communication device and storing the received message in the second storage sub-unit, and storing the received message in the third storage sub-unit when the sending end is not connected to the electronic communication device.

2. The message identification system of claim 1, wherein the first storage sub-unit is used for storing normal messages, the second storage sub-unit is used for storing messages to be identified, and the third storage sub-unit is used for storing junk messages.

3. The message identification system of claim 2 further comprising a changing module for changing storage locations of the received messages stored in the first storage sub-unit, the second storage sub-unit, and the third storage sub-unit.

4. The message identification system of claim 1, wherein the default communication number is one of a plurality of communication numbers of contacts and particular communication services stored in an address book of the electronic communication device.

5. The message identification system of claim 1, wherein the comparison module is used for further comparing the communication number of the sending end with a default junk message communication number, and storing the received message in the third storage sub-unit if the communication number of the sending end is compared to be identical to the default junk message communication number.

6. The message identification system of claim 1 further comprising a changing module for changing storage locations of the received messages stored in the first storage sub-unit, the second storage sub-unit, and the third storage sub-unit.

7. A message identification method applicable to an electronic communication device capable of sending and receiving messages, the message identification method comprising the following steps:
providing a storage unit for storing messages received by the electronic communication device, the storage unit including a first storage sub-unit, a second storage sub-unit, and a third storage sub-unit;
acquiring a communication number of a sending end which sends the messages;
comparing the acquired communication number of the sending end with a default communication number, storing the received message in the first storage sub-unit if the communication number of the sending end is compared to be identical to the default communication number, connecting the electronic communication device with the sending end if the communication number of the sending end is compared to be different from the default communication number, and storing the received message in the second storage sub-unit when the electronic communication device is not connected to the sending end; and
storing the received message in the third storage sub-unit if the communication number of the sending end is compared to be different from the default communication number and the sending end is not connected to the electronic communication device.

8. The message identification method of claim 7, wherein the first storage sub-unit is used for storing normal messages, the second storage sub-unit is used for storing messages to be identified, and the third storage sub-unit is used for storing junk messages.

9. The message identification method of claim 8 further comprising changing storage locations of received messages stored in the first storage sub-unit, the second storage sub-unit, and the third storage sub-unit.

10. The message identification method of claim 7, wherein the default communication number is one of a plurality of communication numbers of contacts and particular communication services stored in an address book of the electronic communication device.

11. The message identification method of claim 7 further comprising comparing the communication number of the sending end with a default junk message communication number, and storing the received message in the third storage sub-unit if the communication number of the sending end is compared to be identical to the default junk message communication number.

12. The message identification method of claim 7 further comprising changing storage locations of received messages stored in the first storage sub-unit, the second storage sub-unit, and the third storage sub-unit.
